(19) United States
(12) Patent Application Publication
(10) Pub. No.: US 2017/0124650 A1
(43) Pub. Date: May 4, 2017

(54) MARKET DATA DISPLAY IN A LOGICALLY ASSOCIATIVE STORYBOARD FORMAT

(71) Applicant: Vertex Analytics, Inc., Chicago, IL (US)

(72) Inventors: James Alan Austin, Evanston, IL (US); Douglas R. Duquette, Glencoe, IL (US); Edward James Gerskovich, Lake Forest, IL (US)

(73) Assignee: Vertex Analytics, Inc., Chicago, IL (US)

(21) Appl. No.: 15/342,789

(22) Filed: Nov. 3, 2016

Related U.S. Application Data
(60) Provisional application No. 62/250,348, filed on Nov. 3, 2015.

(51) Int. Cl. G06Q 40/04; G06F 3/14; G06T 11/20

(52) U.S. Cl. CPC G06Q 40/04; G06T 11/206; G06F 3/14

(57) ABSTRACT

A system is disclosed for data organization and display that incorporates multiple dimensions of data object characteristics to logically and associatively align such data and data elements in a multi-dimensional layout. The layout may include interactive micro and macro behaviors of participants in a forensic quality visual story board representation of events that is easily accessed and understood, and that can be acted upon in both real-time and in a historically informed fashion.

### PRIORITY

This application claims priority to U.S. Provisional App. No. 62/250,348, filed on Nov. 3, 2015, entitled “MARKET DATA DISPLAY IN A LOGICALLY ASSOCIATIVE STORYBOARD FORMAT,” the entire disclosure of which is hereby incorporated by reference.

### BACKGROUND

Electronic trading of global financial markets is one example of a data source that includes daily generated transactional level data. The data may be very large because of both transaction frequency and overall size of the data footprint. Billions of price, quote and trading data objects or particles with variant data characteristics or meta-data may be generated daily. These data streams are so fast, large and growing, that it has become difficult for observation and presentation of markets to, accurately and/or completely describe the market auction process in sufficient detail so as to render the auction process completely transparent and available for observation and investigation in an actionable timeframe. As volatile global markets express themselves, the stakes may be critically high for global economies. There has arisen a requirement to acquire both instantaneous and deeply historically informed information about these vast markets for trading strategy, risk reduction and increasingly (by regulatory imposition) compliance transparency in this era of high frequency, electronic trading systems.

### BRIEF DESCRIPTION OF THE DRAWINGS

A complete visual and quantitative understanding of the light speed interactions of and amongst electronic algorithms within the full range of possible market contexts may be provided in the embodiments described herein. The requirement to have essential real-time and near real-time actionable information may be critical to the integrity of global electronic financial markets. Accordingly, the embodiments described below, for reconstructing the quantitative logic puzzle inherent in these behaviorally generated data streams and organizing/arranging that data or any meta data, or derivative data, inherent in the auction transaction stream, may be used to display the logically generated behavioral information streams within a graphical user interface (GUI) resulting in a simplified format for understanding and interacting with the data.

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a block diagram of an exemplary computing system.

FIG. 2 is a block diagram of an exemplary analyzer apparatus.

FIG. 3 is a flow chart of the data analysis process.

FIGS. 4A and 4B are charts illustrating a sample set of decoded from binary and normalized, raw instruction level transactional data elements.

FIG. 5A is a chart illustrating initial transactional quote data from an auction start.

FIG. 5B is a chart illustrating a ghost mode where the discrete transactional elements are further differentiated from the other previously observed data and also shown within context of the view or subset selected.

FIG. 6A is a chart illustrating a transactional depth state stream within a last few seconds prior to market opening.

FIG. 6B is a chart illustrating a depth state within a last few seconds prior to the market opening for trading with a first match or trade in ghost mode.

FIG. 7 is a chart illustrating a first trade with matched orders view.

FIG. 8A is a chart illustrating a zoomed-out macro view for larger pattern identification.

FIG. 8B is a chart illustrating a zoomed-out macro view for larger pattern identification using ghost mode.

FIG. 9 is a chart illustrating a display of derivative information leveraging a core display construct which indicates the transactional liquidity additions and subtractions of the auction illustrated.

### DETAILED DESCRIPTION

By way of introduction, the disclosed embodiments relate to data organization and display that incorporates multiple dimensions of data object characteristics to logically and associatively align such data and data elements in a multi-dimensional layout. The resulting layout may produce interactive streams of the micro- and macro-serialized behaviors of participants in a forensic quality, visual story board representation of events that is easily accessed and understood, and that may be acted upon in both real-time and in a historically informed fashion.

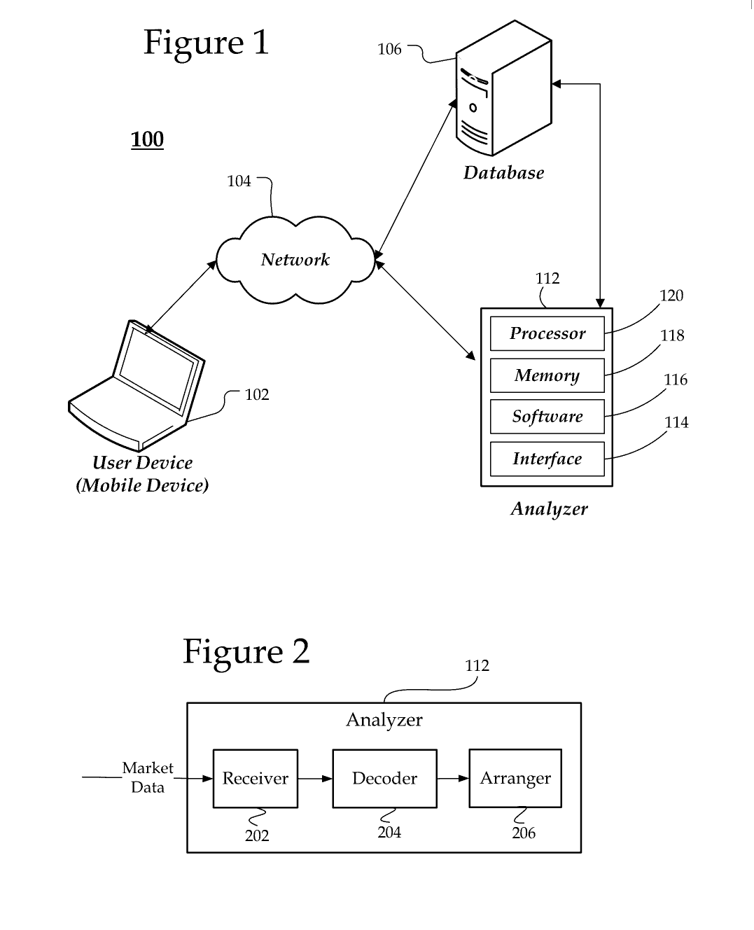

The market analysis, display, and interaction may be performed by a computer or computing device. The device may be part of a network (i.e. a computer network such as the Internet) for communicating information about the network and/or IDs. FIG. 1 illustrates a block diagram of an exemplary computing system 100. The system 100 may include functionality for market analysis, organization, and display. In the system 100, a user device 102 is coupled with a database 106 through a network 104. The analyzer 112 may be or be coupled with a web server that distributes data from the network 104. The analyzer 112 may be coupled with the network 104 and/or the database 106. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The user device 102 may be a computing device which allows a user to connect to the network 104, such as the Internet. Examples of a user device include, but are not limited to, a mobile device, a personal computer, personal digital assistant (“PDA”), cellular phone, or other electronic device. The user device 102 may be configured to allow a user to interact with the database 106, the analyzer 112, or other components of the system 100. The user device 102 may include a keyboard, keypad or a cursor control device, such as a mouse, or a joystick, touch screen display, remote control or any other device operative to allow a user to interact with the database 106 and/or the via the user device 102. The user device 102 may be configured to access other data/information in addition to web pages over the network 104 using a web browser, such as INTERNET EXPLORER® (sold by Microsoft Corp., Redmond, Wash.) or GOOGLE CHROME® (provided by Google). The data displayed by the browser may include market data and/or tracking data. In an alternative embodiment, software programs other than web browsers may also display the data over the network 104 or from a different source.

The database 106 may be a database that stores raw market data. The raw market data may be historical data or streaming/current data. The data stored in the database 106 may be accessed by the analyzer 112. In one embodiment, the database 106 may be combined with or part of the analyzer 112, such as the memory 118. Although not shown, the database 106 may be replaced with or supplemented by a cloud-based application program interface (API) for storing and/or controlling the data. The data stored in the database 106 may be stored in the cloud rather than a physical database or in addition to the database 106.

In one embodiment, there may be a data source providing the raw data for analysis. The database 106 may be the data source in one embodiment, or the data source may be a separate component coupled with the database 106. The data source may be an external source that is coupled with the network 104 for providing data to the database 106 and/or the analyzer 112. In one embodiment, the data source may be the user device 102 as shown in FIG. 1.

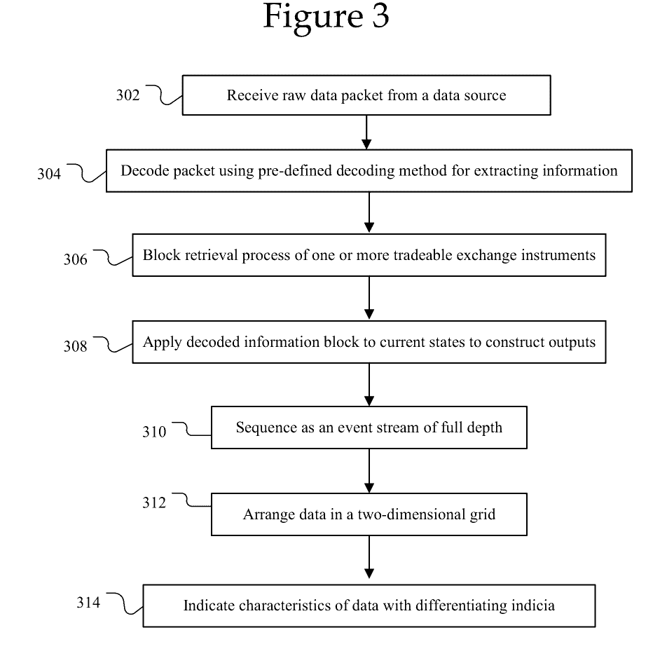

The analyzer 112 may be a computing device for performing analysis, display, and allowing interaction with market data. The analyzer 112 is further illustrated in FIG. 2. The analyzer 112 may include a processor 120, a memory 118, software 116 and an interface 114. In alternative embodiments, the analyzer 112 may be multiple devices to provide different functions and it may or may not include all of the interface 114, the software 116, the memory 118, and/or the processor 120.

The interface 114 may be a user input device or a display. The interface 114 may include a keyboard, keypad or a cursor control device, such as a mouse, or a joystick, touch screen display, remote control or any other device operative to allow a user or administrator to interact with the analyzer 112. The interface 114 may communicate with any of the user device 102, the database 106, and/or the analyzer 112. The interface 114 may include a user interface configured to allow a user and/or an administrator to interact with any of the components of the analyzer 112. For example, the administrator and/or user may be able to access the database through the interface 114. The interface 114 may include a display coupled with the processor 120 and configured to display an output from the processor 120. The display (not shown) may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing data.

The processor 120 in the analyzer 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with the memory 118, or the memory 118 may be a separate component. The software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded tracking data, or an analysis of the data. Examples include a hard drive, compact disc (“CD”), digital video disc (“DVD”), memory card, memory stick, floppy disc, universal serial bus (“USB”) memory device, or any other device operative to store data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116.

The present disclosure contemplates a computer-readable medium that includes instructions or receives and executes instructions responsive to a propagated signal, so that a device connected to a network can communicate voice, video, audio, images or any other data over a network. The interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

Any of the components in the system 100 may be coupled with one another through a (computer) network, including but not limited to the network 104. For example, the analyzer 112 may be coupled with the database 106 and/or the user device 102 through a network. Accordingly, any of the components in the system 100 may include communication ports configured to connect with a network. The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

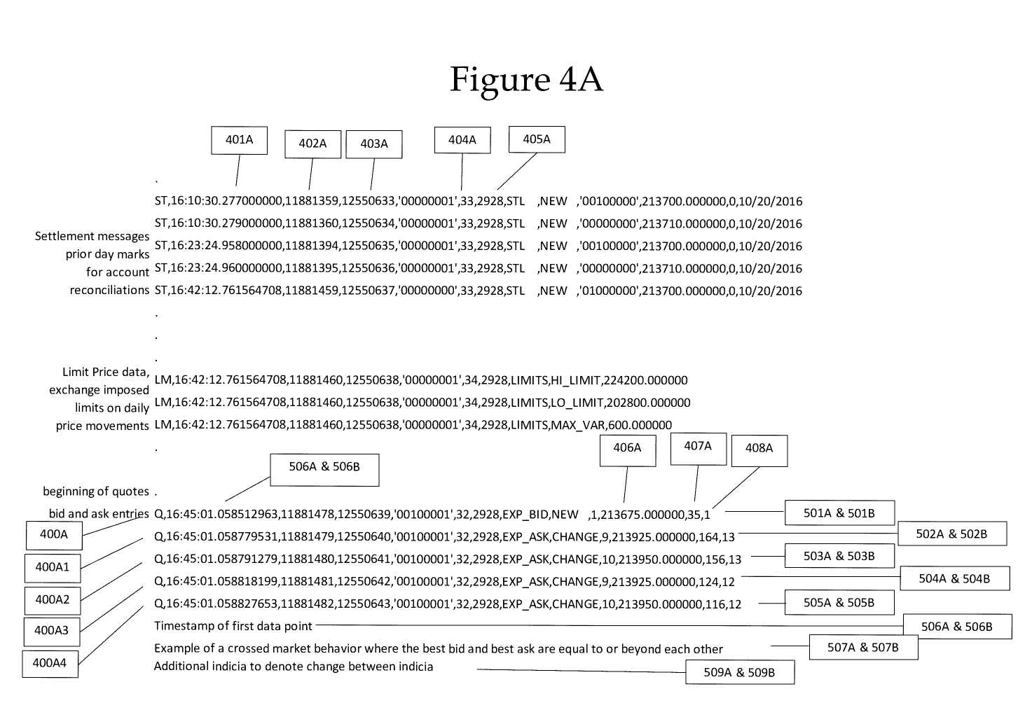

FIG. 2 illustrates a block diagram of an exemplary analyzer 112. The analyzer 112 may receive market data at a receiver 202. The received market data at the receiver 202 may be decoded by a decoder 204. The decoded data from the decoder 204 may be displayed and organized by an arranger 206. The operations of the analyzer 112 and the receiver 202, the decoder 204, and the arranger 206 are further described with respect to FIG. 3.

FIG. 3 is a flow chart of the data analysis process. In block 302, a raw data packet is received from a data source. As described with respect to FIG. 1, the data source may be external to the system 100 and provided over the network 104, or may be part of or coupled with the database 106. In one embodiment, the raw data packet may be received by the receiver 202 shown in FIG. 2. The raw data may include data from electronic financial market exchanges. The data may be transmitted and received using a multicast stream of universal data packets (UDP) to optimize efficiency of data delivery to multiple endpoints in a timely manner. Moreover, electronic exchanges have largely evolved their electronic market data distribution systems, protocols, and APIs to allow for minimal time to decode the typically binary stream of data. The raw packets of binary data received via the multicast stream typically contain variable length, byte aligned data buffers. These data buffers include leading sections of exchange specified lengths dedicated to header information which can be read first from the wire to identify how the remaining buffer of data should be (a) read by length and (b) filtered through an exchange defined decoding template. Exchange defined templates typically consist of structured sets of software objects that include variable length data types that explicitly describe various transactional elements of the auction. These templates are exchange provided in order to synchronize distributed communication amongst participants and allow for the decoding and normalization of the particular exchange instructions or new information items contained within each message on the transactional stream. A raw packet may contain one or more variable length transactional messages or instructions corresponding to each serialized new piece of information describing the auction process. Each exchange typically has both common and unique protocol attributes. Those skilled in the art can easily translate the methods described herein to each electronic exchange's protocol requirements.

In block 304, each message in a raw data packet may be decoded using a pre-defined decoding method as described. The decoding may extract information from each message. In one embodiment, the raw data packet may be decoded by the decoder 204 shown in FIG. 2. Each packet of the raw multicast stream may be decoded from the binary according to a specific protocol as defined and imposed by each exchange in order to extract the individual content of each sub message within each packet.

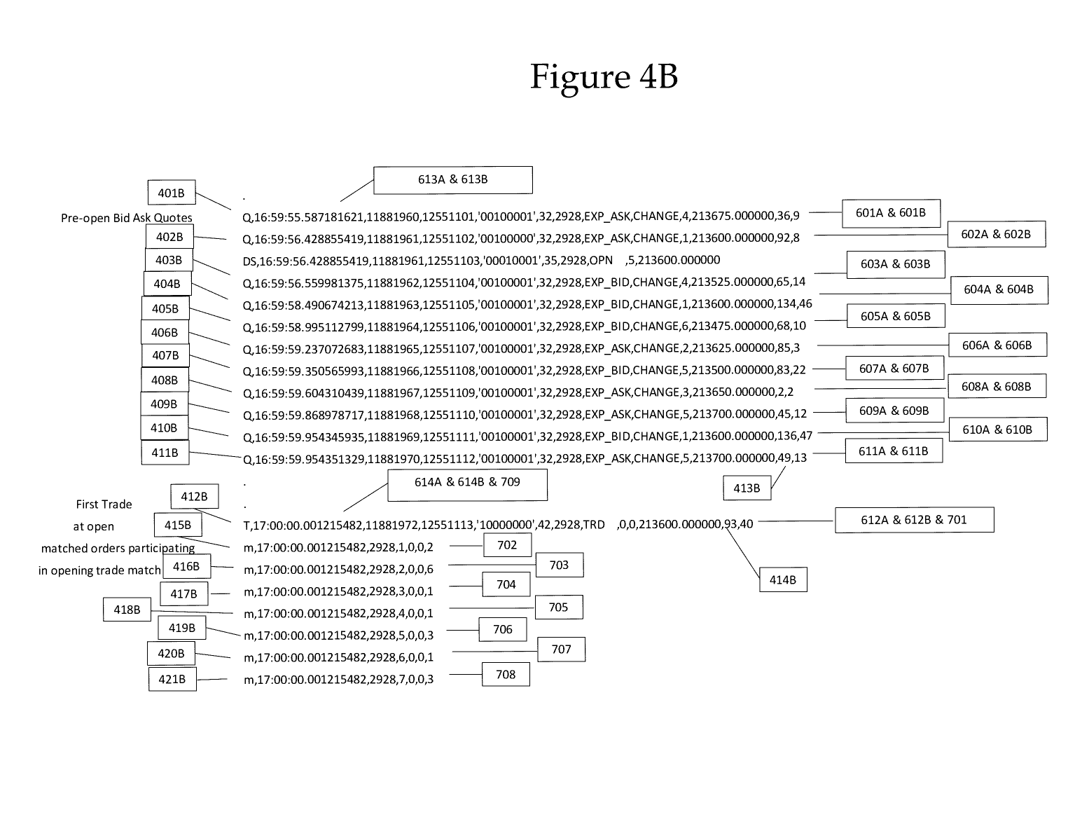

In block 306, a block retrieval process may be used on the decoded information. The process may be for one or more tradeable exchange instruments. Specifically, block 306 indicates the process of storing the decoded messages into a normalized format for rapid retrieval on demand as illustrated in FIGS. 4A and 4B.

FIGS. 4A and 4B are charts illustrating a sample set of decoded data from binary and normalized, raw instruction level transactional data elements. Typically, the normalized transactional data elements comprise informational content including but not limited to time stamp with granularity which may be generally at least milliseconds and in some instances nanoseconds (401A), a packet level sequence number (402A), and in some instances, an instrument level sequence (403A). Numeric sequencing of transactional data elements may be provided to mark the ordering of the transactional stream. It is important to understand that the recorded sequencing of events is critical to the forensic integrity of the data and to the presentation of the resulting outputs as a process for verification that the output represents a true and accurate reproduction of participant behavior as it occurs and/or when it occurred. A message type (404A) indicating expected content and usage of the particular message may be provided. A numeric identification (405A) of the particular tradeable instrument shown in (405A) as 2928 is an example illustration. The usage, in any combination, of time stamp, packet sequence number, in some instances instrument level sequence number and instrument identification ensures the proper sequencing of individual messages corresponding to actual actions completed by participants during the course of the auction process within the scheduled times as specified by an exchange. A price (406A) at which the transaction occurred may be provided by an exchange. Additionally, a quantity (407A) and a number of orders (408A) comprising the quantity (407A) may be provided as examples of included metadata or actionable characteristics comprising additional dimension information for use in certain embodiments as described further herein.

Referring back to FIG. 3, blocks 302, 304 and 306 comprise a prerequisite process inclusive of the collection, decoding, parsing, normalizing and storage of the data into blocks of messages, where each block of decoded messages generally comprise the entirety of messages specifically belonging to each individual tradeable instrument listed for trade by a particular exchange on a given trade date. Moving to block 308, there may be an Application Programming Interface (API) process applied to the transactional message information content and context stream derived from the decoded, normalized, stored and indexed information blocks into discrete current market states and construct a serialized market state stream as of each sequential new information message consisting of bid quotes or bid to buy the tradeable instrument at a particular price, ask quotes or offer to sell the tradeable instrument at a particular price or matched trades which occur when a live bid quote's price is greater than or equal to a live offer quote price. The API may be developed to retrieve the decoded and normalized messages as shown in FIGS. 4A and 4B from a data storage medium in order to enable a client software component within which embodiments have been implemented and apply the embodiments for subsequent consumption of the realized information content generated by the embodiments. The API may include a pre-defined schema for the process.

Regardless of the specific implementation details of any API developed to feed data, one requirement of the API may be to be able to retrieve and serve the stored message stream and feed the retrieved data block into the embodiments as a sequentially ordered stream of actions taken by the participants as in FIGS. 4A and 4B. In one embodiment, each message that is broadcast on a stream from an exchange may be referred to as a piece of “new” information that updates the current last known state of the auction as it proceeds. The information is either a new piece of information about a quote or bid to buy the tradeable instrument at a particular price (406A, 501A, 501B) for a particular quantity (407A), new information about a quote or an offer to sell the tradeable instrument at a particular price (422B,611A,611B) for a particular quantity (413B), or new information about a match between a bid and an offer which may also be known as a trade (412B, 612A,612B,701) for a particular quantity (414B).

A stream of new quote information that does not result in an immediate match or trade may become part of the current state of the depth of market. The depth of market is may refer to a composition all of the bid quotes willing to buy but not yet matched and all of the offer quotes willing to sell but not yet matched as of the arrival of the last known new information from the exchange stream. As such, the API implementation can derive and maintain the serialized transactional states of the depth of market which is a process that may be subject to the particular specifications as imposed by the exchange from which the data is sourced.

The following disclosed embodiments may expand the current state model. The embodiments render completely transparent, the serialized stream of information content inherent within a stream of sequential transactional states where each individual state is the result of the incorporation of the new information that arrived in sequence transactional messages over time. A sequence of messages may be displayed as an event stream of full depth and trade in block 310 of FIG. 3. Each observed transactional element of the depth may be displayed at its respective price in each column at 501A. Each trade may be displayed at its respective price with its respective column as shown at 612A.

The exemplary data messages shown in FIGS. 4A and 4B are exemplary decoded and normalized data elements received from a data source. One example of a data source is the CME GROUP GLOBEX(™) system for ESZ6. Starting with the first message (400A), the new piece of information may be a new bid at a price of 213675 (406A) with a bid quantity of 35 contracts (407A) and that quantity is contained within only 1 order (408A).

Referring back to FIG. 3, each transactional data element may be arranged in a two-dimensional grid in block 312. The two-dimensional grid may include an x-axis that is the element count or sequence number of a new information item, and a y-axis that is located according to a characteristic of the new information item, such as a price (406A) value. The rightmost new information object may be the most recent or last known information item reflected as incorporated into the representation of state as derived from the process of blocks 308 and 310. The leftmost may be the oldest sequential and consecutive element that can fit within a given scale view. The number of elements traversing along the y-axis in a depth or trade column may or may not be limited.

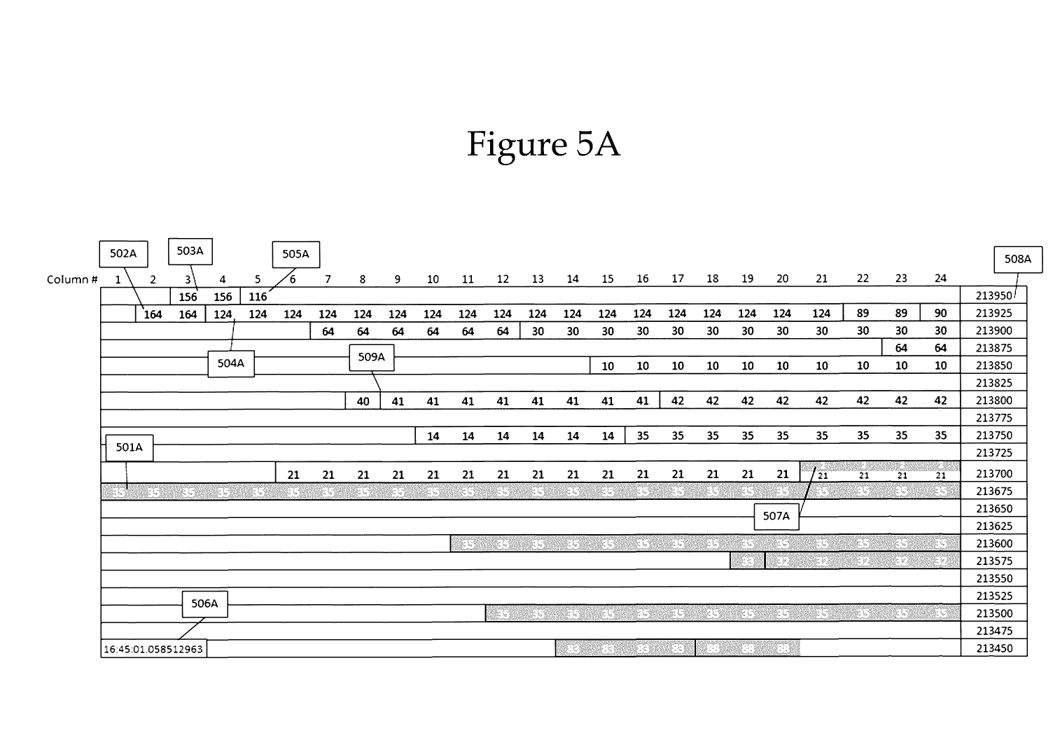

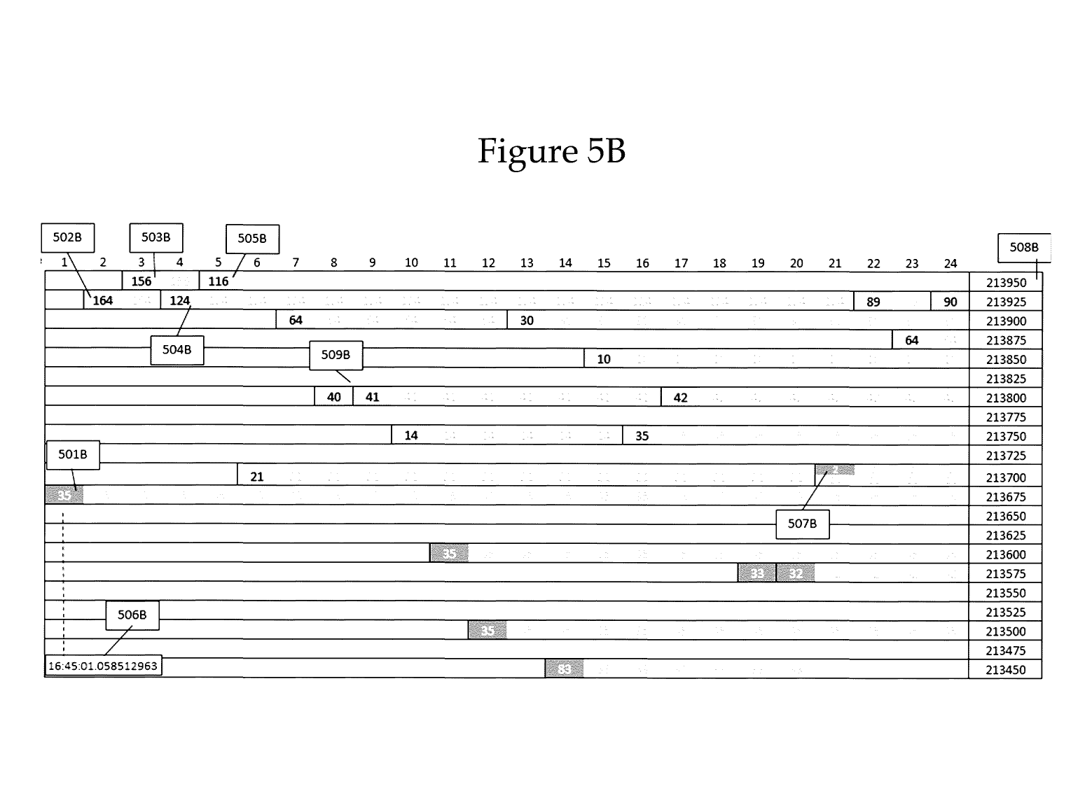

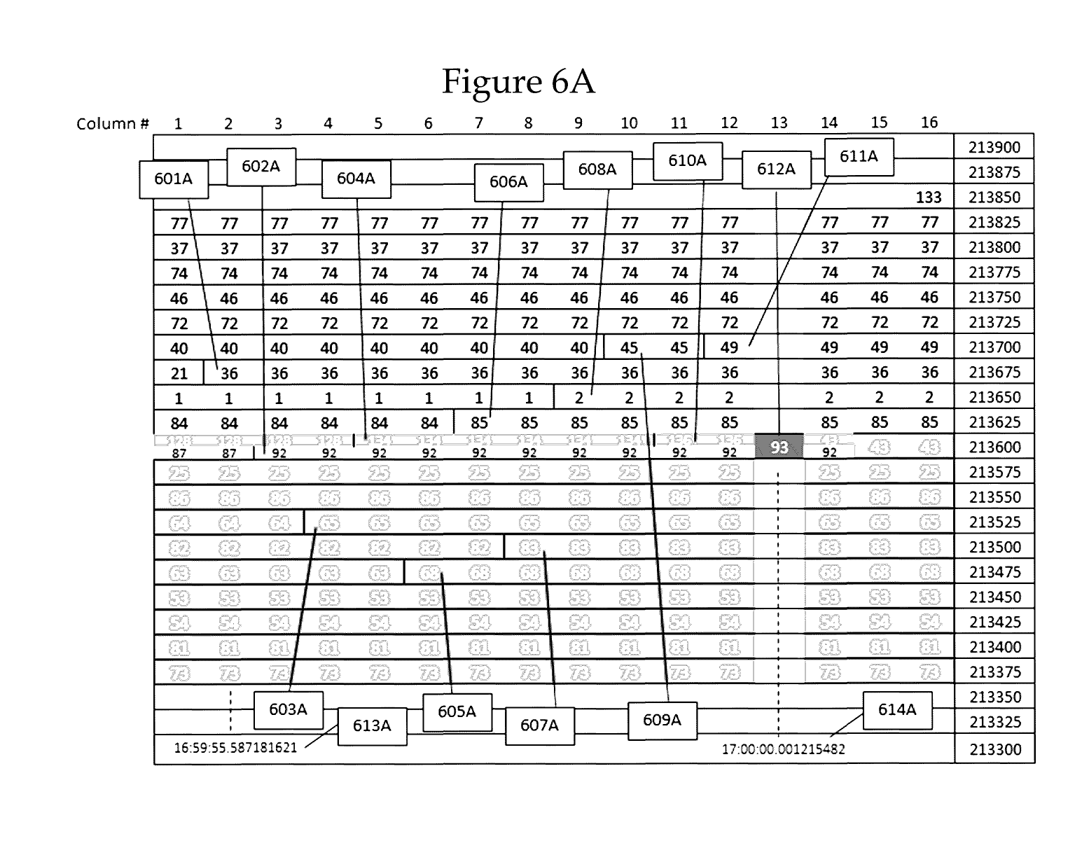

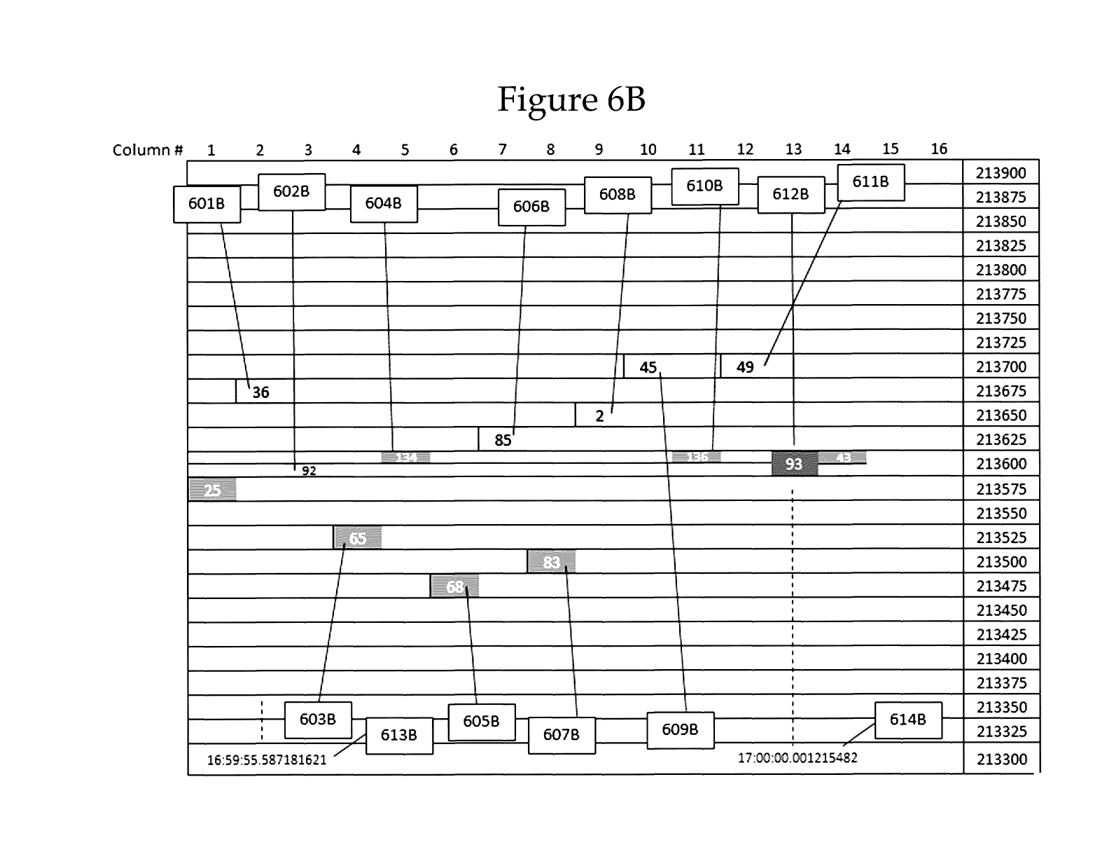

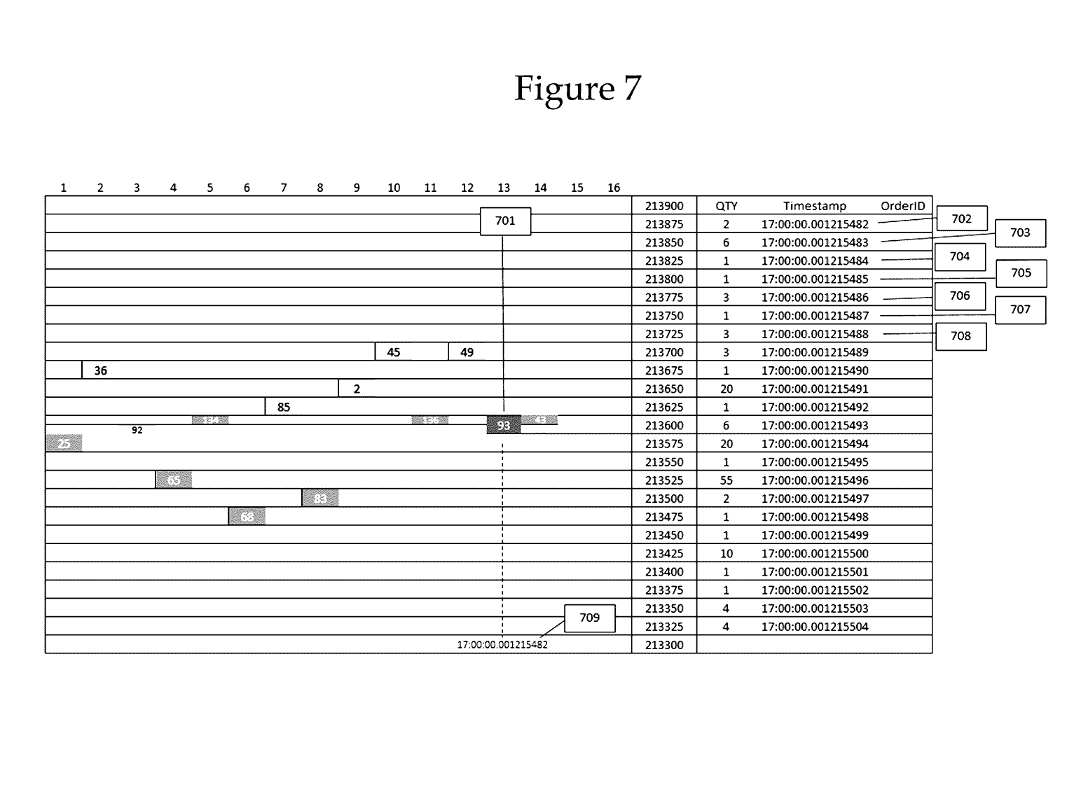

In one embodiment, the arrangement of data in block 312 may be by the arranger 206 shown in FIG. 2 and resulting in possible displays as represented in FIGS. 5A, 5B, 6A, 6B, 7, 8A, 8B, and/or 9 with explicit mappings from those Figures to the explicit raw decoded and normalized data elements shown in FIGS. 4A and 4B, respectively. In one embodiment, 400A is represented in FIGS. 5A and 5B as corresponding to 501A and 501B, respectively, and 412B is represented as corresponding to 612A and 612B in FIGS. 6A and 6B and 701 in FIG. 7, while 411B is represented in FIGS. 6A and 6B at 611A and 611B respectively. As indicated at 508A and 508B, there may be a price scale along the y-axis to which each data element is mapped in the sequence of its arrival along the x-axis. The information content of each discrete message is preserved in serial states such as the quantity of 35 at 501A that is carried forward in each of the columns 1 through 24 in FIGS. 5A and 5B indicating that the state of the market at a price of 213675 (406A) remained unchanged for the series of messages depicted in FIG. 5A. FIG. 5A is a chart illustrating initial transactional quote data from an auction start. The data and markings shown are also indicated in FIG. 4A and marked as items 501A through 509A. FIG. 5B is a chart illustrating a ghost mode where the transactional elements of are differentiated from the other data also within context of the view or subset selected. The data and markings shown are also indicated in FIG. 4A and marked as items 501B through 509B.

On the data display, characteristics of each transactional data element may be indicated with differentiating indicia as in block 314 of FIG. 3. For example, coloring may be used to inform of large scale common group characteristics. In one embodiment of FIG. 5A, ask orders pending may be indicated as a lighter shading at 502A, 503A, 504A, and 505A, while bids may be a darker shade at 501A and 507A. Alternatively, the differentiating characteristic may include size, color, font, or other differentiators in addition to shading. In addition, elements other than elements changing from message to message may be grayed out, while new information may be so indicated per frame or column using coloring or shading to further differentiate not only the state but also what is changing message by message or column by column as shown at 501B, 502B, 503B, 504B 505B and 507B by way of example. In one embodiment, the indicia of characteristics in block 314 may also be by the arranger 206 shown in FIG. 2.

In FIG. 5A, a first message (400A) of the current auction includes indicia in the initial displayable column 1 which corresponds to the time stamp (506A and 506B) of that discrete new transactional information object. Since this is the first piece of information for an auction session, no other information is displayed in column 1. As of this data object, only a single piece of information exists about this auction thus far. The indicia are further oriented in the 2-dimensional grid relative to the y-axis where the y-axis is a representation of the prices (508A) available in this particular market at which quotes to bid or offer and trades may occur. For each quote or trade message in FIG. 4A, elements 400A, 400A1, 400A2, 400A3, 400A4 corresponding to 502A, 503A, 504A, 505A, as the indicia are similarly located on the 2-dimensional grid in FIG. 5A where each new transactional message item may be incorporated to the current state, which as of (400A1), includes two elements. The first element is a bid for a quantity of 35 (407A) for a price of 213675 (406A) carried forward from (501A) to column 2 as it is current information as of the last know update from the exchange, and the second element in the current state is a new offer (400A1) with a quantity of 164 oriented (502A) in column 2 relative to the Y axis (508A) at a price of 213925. This process may be repeated for items 400A2, 400A3, 400A4 for each transactional new information message broadcast from the exchange for each tradeable instrument active for a given trade date. Each transactional new information object may be incorporated into the then current state; the state is adjusted and displayed as shown in the embodiments described herein. Item 507A is an example of the display embodiment of splitting a grid location and sharing the occupied space to show where two pieces of information share a common time and price characteristic. This state is legitimate for certain market states as prescribed by each exchange. In this particular example, the market is a pre-open state where bids and offers are allowed to be placed without matches taking place until a time certain open where normal matching or trades can occur.

FIG. 5B is a chart illustrating a ghost mode where only the elements changing as of each new transactional information message are differentiated at yet another level. FIG. 5B is an alternative embodiment using the same data elements and processes as described in FIG. 5A and as processed from data examples 400A, 400A1, 400A2, 400A3, 400A4 whereby the indicia for each new piece of information is differentiated in some manner and the existing information from prior states and columns are consistent indicating no change for that piece of information as of each new column. However, the transactional elements are explicitly differentiated further to show change within the context of serialized sequential states of the market under observation.

Referring now to FIG. 4B in conjunction with FIGS. 6A and 6B. FIG. 6A is a chart illustrating a transactional depth state stream within a last few seconds prior to market opening. The data and markings shown are also indicated in FIG. 4B and marked as items 601A through 614A. FIG. 6B is a chart illustrating a depth state within a last few seconds prior to the market opening for trading with a first match or trade in ghost mode. FIG. 6B is similar in to the previous descriptions and embodiment of FIG. 5B. The data and markings shown are also indicated in FIG. 4B and marked as items 601B through 614B. Specifically, FIG. 6A is a chart illustrating a depth state within a last few seconds prior to market opening of the same market instrument on the same date as described previously but stepping into the data stream approximately 15 minutes later and approximately 5 seconds before the market shown opens for trading and including the opening trade sequence.

As with the other embodiments and Figures, this data and its format is merely exemplary and the embodiments are not limited to this exemplary data. FIG. 6B is a chart illustrating the serialized depth state using the data from FIG. 4B and shown and described in FIG. 6A, but includes a ghost display mode similar to that described previously for FIG. 5B and related to the data messages in FIG. 4B and the display method shown in FIG. 6A. Beginning with the block of messages in FIG. 4B, and particularly timestamp 613A, we see that this data block begins roughly 15 minutes after the block of messages in FIG. 4A and less than 5 seconds prior to the scheduled 17:00:00 CST opening for trading of the example market. From FIG. 4B we see the new information content of each message listed as items 401B, 402B, 403B, 404B, 405B, 406B, 407B, 408B, 409B, 410B, 411B as having been incorporated into FIG. 6A at 601A, 602A, 603A, 604A, 605A, 606A, 607A, 608A, 609A, 610A, 611A respectively and including the item 412B which is the opening trade of this auction for this instrument on this date 612A. Referring to FIG. 6B, the addition of new information can be more easily seen in the next tier of differentiating indicia of the ghost mode as described and illustrated previously using the same transactional data objects and alignments on the grid as previously described and illustrated in FIG. 6A.

FIG. 7 is a chart illustrating a trade with matched orders view. The data and markings shown are also indicated in FIG. 4B and marked as items 701 through 708. FIG. 7 includes a closer inspection of item 612A and 612B from FIGS. 6A and 6B, which is the opening trade. In FIG. 7, item 701 may be an isolated trade event as the next new information object sequence is discretely sandwiched between two depth updates to the left and right of the trade item 701. Items 702, 703, 704, 705, 706, 707, 708 correspond to items 415B, 416B, 417B, 418B, 419B, 420B, 421B, respectively, and depict the individual orders that were matched during this trade event and displayed accordingly in the window as shown. Item 709 illustrates the time stamp of the 701 trade event message and corresponds with the time stamp of item 412B message and 709. The matched orders are disseminated in sequence post a trade event message as shown in FIG. 4B as items 415B, 416B, 417B, 418B, 419B, 420B, 421B.

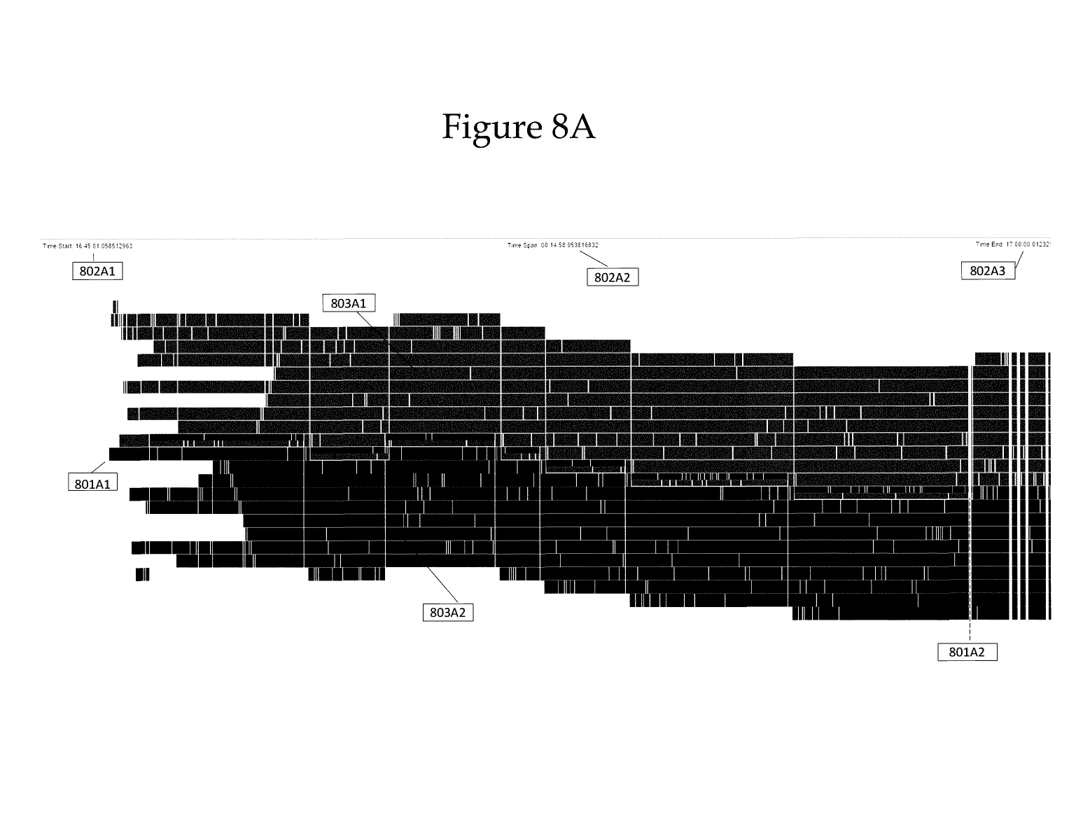

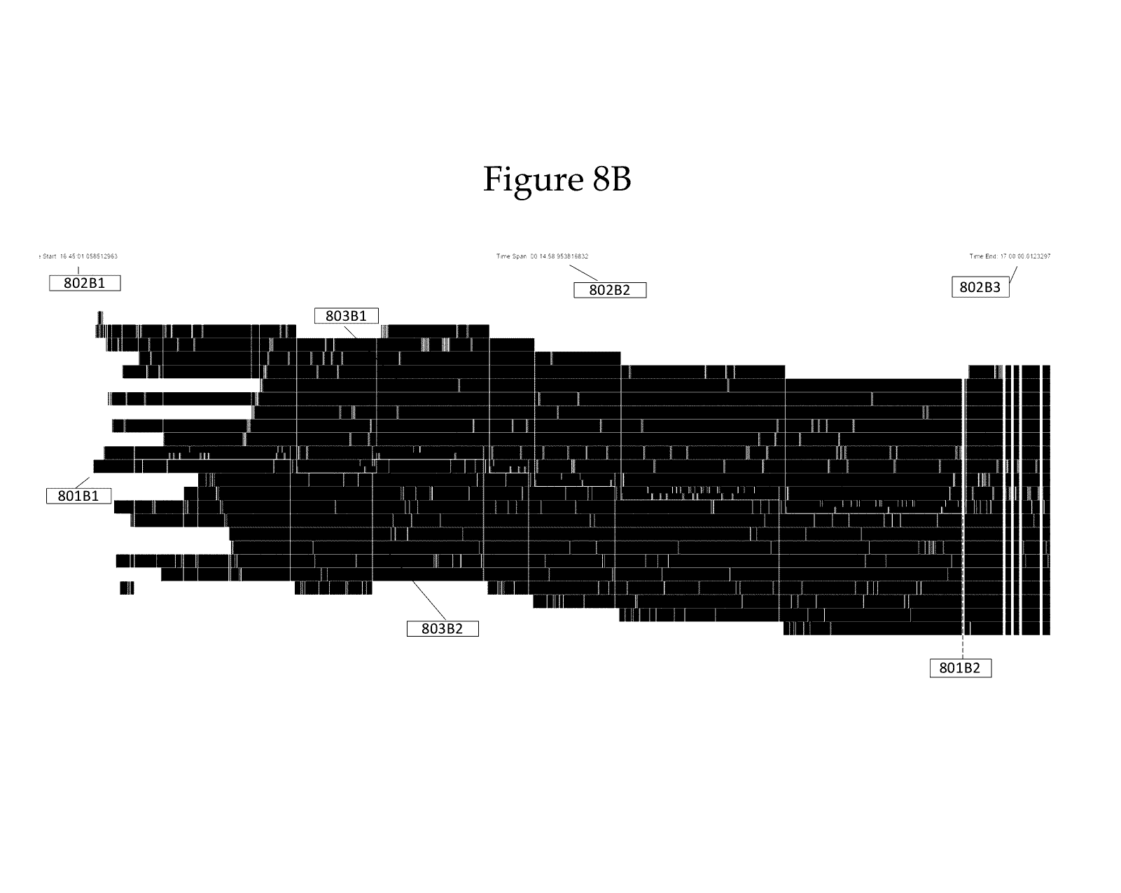

FIG. 8A is a chart illustrating a zoomed-out macro view for larger pattern identification across a broader spectrum of transactional data objects. The data and markings shown are a superset of the transactional data message items indicated in FIGS. 4A and 4B. The data indicated in FIGS. 4A and 4B corresponds to the data contexts beginning at 801A1 first quotes, and also including 801A2 first trade.

FIG. 8B is a chart illustrating a zoomed-out macro view for larger pattern identification using ghost mode. The data and markings shown are a superset of the transactional data items indicated in FIGS. 4A and 4B. The data indicated in FIGS. 4A and 4B corresponds to the data contexts beginning at 801B1 first quotes, and also including 801B2 first trade.

Both FIGS. 8A and 8B incorporate the data messages in FIGS. 4A and 4B as used, identified and described herein and so indicated at 801A1 and 801A2 and additionally include other messages that occurred in the record of sequential transactional messages for the tradeable instrument described on the date in aggregate indicated between time stamps 802A1 and 802A3 and corresponding to 400A and 412B, respectively. The resulting data views can be zoomed in and out to various scales using indicia of choice to observe and inspect the explicit micro and macro patterning of the auction process as a whole and additive to our increasing understanding of the underlying auction process. The differentiation by coloring and shading (as merely two differentiation mechanisms) of the indicia for each message type is shown as the field of coloring at 803A1 and 803A2. The differentiated indicia render transparent the flow of liquidity over time and along the price scale indicated on the y-axis. FIG. 8B is the same data set as FIG. 8A, while differentiating by an alternative method of indicia to indicate change and relative location of each new transactional information object and any new information clusters that may be inherent in the stream. FIG. 8B illustrates the method of the micro patterning of participant behaviors in the context of as yet unchanging static information. FIG. 8B is similar to FIGS. 5B, and 6B but zoomed out in scale to show a larger section of data elements and clustering of behavioral patterns of participants.

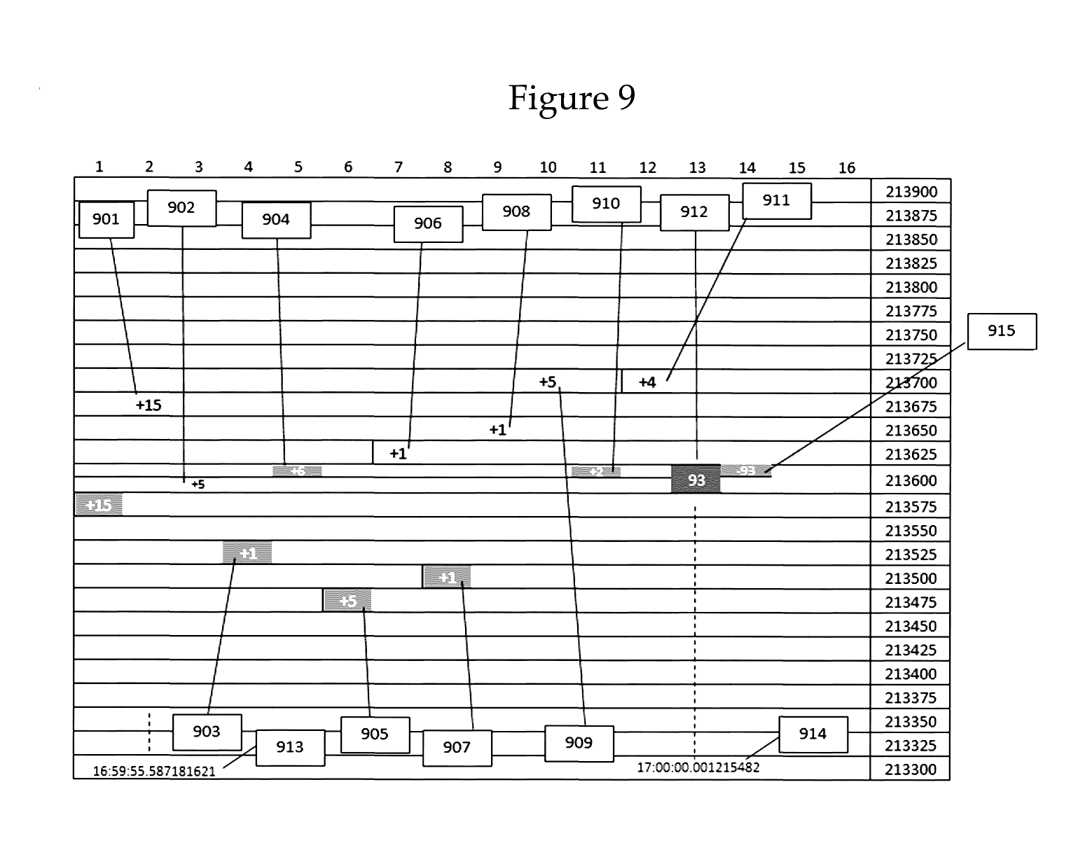

FIG. 9 is a chart illustrating a display of derivative information leveraging a core display construct which indicates the transactional liquidity additions and subtractions of the auction. The data and markings shown are also indicated in FIG. 4B and marked as items 601A through 614A and 701. FIG. 9 presents an additional dimension of relational information content from the same and between the underlying data inputs and incorporates one embodiment of data arrangement as described and additionally differentiates the indicia by the new information of a behavioral orientation. In one embodiment, at 915, a quantity of 93 may be removed from the liquidity available at that price after the trade event of quantity 93 occurred at 912. Additionally, 901, 902, 903, 904, 905, 906, 907, 908, 909, 910, 911 are each new pieces of information showing how liquidity was added or withdrawn accordingly as of that particular message corresponding to that particular column and indicated with a preceding “+” for liquidity additions and a “−” for liquidity withdrawals in one example. For orientation, the timestamps at 913 and 914 correspond to the timestamps in the messages at 401B and 412B respectively. FIG. 9 reveals how the liquidity dynamics are changing message by message. It is the combinations of the raw transactional messaging and the tiered logical display methods that allow for multi-dimensional information contexts to be displayed and observed for all dimensions of the behavioral contexts of an electronic auction market.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for associative storyboarding comprising:
receiving data from a data source;
decoding the received data for extracting information about the data;
displaying the extracted information in a two-dimensional grid includes a sequence on the x-axis and a characteristic on the y-axis; and.
including indicia on the displayed grid.

2. The method of claim 1 wherein the data comprises raw market data.

3. The method of claim 2 wherein the market data comprises bid and ask prices for order.

4. The method of claim 2 wherein the information comprises metadata related to the market data.

5. The method of claim 2 wherein the x-axis includes information arranged based on how recently the market data was received.

6. The method of claim 1 wherein the displaying is on a graphical user interface.

7. The method of claim 1 wherein characteristic comprises a price.

8. In a non-transitory computer readable storage medium having stored therein data representing instructions executable by a programmed processor for displaying market data, the storage medium comprising instructions operative for:
receiving the market data from a data source, wherein the market data comprises a stream of data;
sequencing the market data based on timing;
displaying the sequenced market data into grid based on the sequencing.

9. The storage medium of claim 8 wherein the market data comprises bid and ask prices for order.

10. The storage medium of claim 8 wherein the displaying is on a graphical user interface.

11. A computer system comprising:
a receiver configured for receiving market data from a data source;
a decoder configured for decoding the market data into decoded data;
an arranger configured for arranging the decided data into a series of indicia with both a horizontal and a vertical relativity.

12. The computer system of claim 11 wherein the horizontal and the vertical relativity comprises a two-dimensional grid includes a sequence on the x-axis and a characteristic on the y-axis.

13. The computer system of claim 12 further comprising:
a display for displaying the grid.
